(19) United States
(12) Patent Application Publication
(10) Pub. No.: US 2018/0099761 A1
(43) Pub. Date: Apr. 12, 2018

(54) Real Time Aircraft Stress Monitoring System

(71) Applicant: The Boeing Company, Chicago, IL (US)

(72) Inventors: Robert C. Griffiths, Seattle, WA (US); Mitchell D. Voth, Federal Way, WA (US)

(21) Appl. No.: 15/289,477

(22) Filed: Oct. 10, 2016

(51) Int. Cl. B64D 45/00; G06T 7/20; H04N 7/18; B64D 47/08

(52) U.S. Cl. CPC B64D 45/00; G06T 7/2033; H04N 7/181; B64D 2045/0085; B64D 47/08; G06T 2207/10032; G06T 2207/30252; G06T 7/2093

(57) ABSTRACT

A method and apparatus for an aircraft monitoring system. The aircraft monitoring system comprises targets associated with the wing of the aircraft, a camera system and a monitor. The camera system is configured to generate images of the targets on the wing during operation of the aircraft. The monitor is configured to measure movement of the targets using images, enabling identifying wing movement.

### BACKGROUND INFORMATION

### 1. Field

The present disclosure relates generally to an improved aircraft and, in particular, to a method and apparatus monitoring an aircraft. Still more particularly, the present disclosure relates to a method and apparatus for monitoring stress on an aircraft during operation of the aircraft using vibrations detected using a camera system.

### 2. Background

In developing and testing an aircraft, flight tests are performed on the aircraft. Flight testing is performed as part of the development of the aircraft and also for certification of the aircraft. The flight testing is performed to gather data during flight of the aircraft. This data is analyzed to evaluate aerodynamic flight characteristics of the aircraft as well as structural characteristics to validate the design of the aircraft. This data is also used to identify different safety aspects for the aircraft.

In flight testing, it is desirable to find and resolve any undesired characteristics that may occur during flight. These undesired characteristics may include fuel efficiency, amount of sound generated, maneuverability, or other characteristics that do not meet desired specifications for the aircraft.

For example, movement of different structures of the aircraft during flight is monitored. The movement may be, for example, vibrations, bending, twisting, or other types of movement that result in stress on an aircraft structure, such as a wing of the aircraft.

Currently, data about vibrations or other dynamic movements is gathered using accelerometers. Using accelerometers to measure vibrations is often more cumbersome than desired. Using accelerometers involves substantial wiring and is a labor-intensive process. Further, the accelerometers also require calibration which is also a labor-intensive process. As a result, using accelerometers may be more expensive and time-consuming than desired. Further, the use of accelerometers and their associated instrumentation also may increase the weight of the aircraft more than desired for testing purposes.

Therefore, it would be desirable to have a method and apparatus that takes into account at least some of the issues discussed above, as well as other possible issues. For example, it would be desirable to have a method and apparatus that can overcome a technical problem by measuring both static and dynamic movements of aircraft structures.

### SUMMARY

An embodiment of the present disclosure provides an aircraft monitoring system. The aircraft monitoring system comprises targets associated with the wing of the aircraft, a camera system and a monitor. The camera system is configured to generate images of the targets on the wing during operation of the aircraft. The monitor is configured to measure movement of the targets using images, enabling identifying wing movement.

Another embodiment of the present disclosure provides a real-time aircraft stress monitoring system. The real-time aircraft stress monitoring system comprises elliptical targets associated with the wing of the aircraft, a camera system and a monitor. The camera system is configured to generate images of the elliptical targets on the wing during operation of the aircraft. The monitor measures movement of the elliptical targets using the images and identifies the stress in the wing based on the movement of the elliptical targets.

Yet another embodiment of the present disclosure provides a method for monitoring movement of an aircraft structure. Images of targets on the aircraft structure are generated using a camera system associated with an interior of an aircraft during operation of the aircraft. Measuring the movement of the targets using the images enables identification of the movement of the aircraft structure.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is an illustration of a block diagram of an aircraft monitoring environment in accordance with an illustrative embodiment;

FIG. 2 is an illustration of a block diagram of a more detailed example of an aircraft monitoring system in accordance with an illustrative embodiment;

FIG. 3 is an illustration of a wing with targets in accordance with an illustrative embodiment;

FIG. 4 is an illustration of a wing with elliptical targets in accordance with an illustrative embodiment;

FIG. 5 is an illustration of a deflection of a wing in accordance with an illustrative embodiment;

FIG. 6 is an illustration of a cross-sectional view of a wing in accordance with an illustrative embodiment;

FIG. 7 is an illustration of a waterline deflection along stations extending longitudinally along a roll axis in accordance with an illustrative embodiment;

FIG. 8 is an illustration of a flowchart of a process for monitoring movement of an aircraft structure in accordance with an illustrative embodiment;

FIG. 9 is an illustration of a flowchart of a process for performing an operation in response to identifying stress in an aircraft structure in accordance with an illustrative embodiment;

FIG. 10 is a flowchart of a process for identifying movement of a target in images in accordance with an illustrative embodiment;

FIG. 11 is an illustration of a block diagram of a data processing system in accordance with an illustrative embodiment;

FIG. 12 is an illustration of a block diagram of an aircraft manufacturing and service method in accordance with an illustrative embodiment;

FIG. 13 is an illustration of a block diagram of an aircraft in which an illustrative embodiment may be implemented; and

FIG. 14 is an illustration of a block diagram of a product management system in accordance with an illustrative embodiment.

### DETAILED DESCRIPTION

The illustrative embodiments recognize and take into account one or more different considerations. For example, the illustrative embodiments recognize and take into account measuring movement of aircraft structures may be performed using techniques other than accelerometers. For example, the illustrative embodiments recognize and take account that some systems may be used to generate images of targets. The movement of targets between images may be used to identify movement in an aircraft structure. In this manner, vibrations and stress in the structure may be identified more easily as compared to using accelerometers.

Thus, the illustrative embodiments provide a method and apparatus for monitoring movement of an aircraft structure. In one illustrative example, an aircraft monitoring system comprises targets, a camera system, and a monitor. The targets are associated with the aircraft structure, such as a wing of an aircraft. The camera system is configured to generate images of the targets on the wing during operation of the aircraft. The monitor measures any movement of the targets using the images, enabling identifying wing movement.

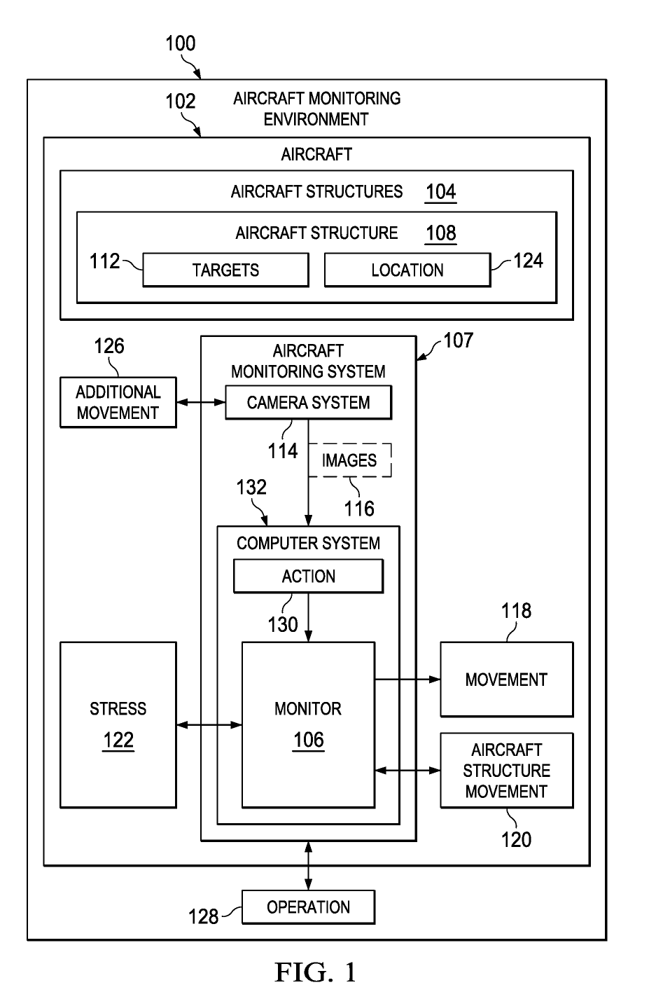

With reference now to the figures and, in particular, with reference to FIG. 1, an illustration of a block diagram of an aircraft monitoring environment is depicted in accordance with an illustrative embodiment. In this illustrative example, aircraft monitoring environment 100 includes aircraft 102. Aircraft 102 may take a number of different forms. For example, aircraft 102 may be selected from a group comprising an airplane, a rotorcraft, a commercial aircraft, a military aircraft, or some other suitable type of aircraft.

One or more of aircraft structures 104 are monitored using monitor 106 in aircraft monitoring system 107. Aircraft structures 104 include at least one of a wing, a horizontal stabilizer, a vertical stabilizer, an aileron, a flaperon, a flap, an elevator, a rudder, a spoiler, a slat, an engine housing, a nacelle, a fairing, or some other suitable type of aircraft structure. For example, monitor 106 may monitor aircraft structure 108 in aircraft structures 104.

As used herein, the phrase “at least one of”, when used with a list of items, means different combinations of one or more of the listed items may be used, and only one of each item in the list may be needed. In other words, “at least one of” means any combination of items or number of items may be used from the list, but not all of the items in the list are required. The item may be a particular object, a thing, or a category.

For example, without limitation, “at least one of item A, item B, or item C” may include item A, item A and item B, or item B. This example also may include item A, item B, and item C or item B and item C. Of course, any combination of these items may be present. In some illustrative examples, “at least one of” may be, for example, without limitation, two of item A, one of item B, and ten of item C; four of item B and seven of item C; or other suitable combinations.

As depicted, targets 112 are also part of aircraft monitoring system 107 and are associated with aircraft structure 108. When one component is “associated” with another component, the association is a physical association. For example, a first component, a target in targets 112 may be considered to be physically associated with a second component, aircraft structure 108, by at least one of the targets being secured to the second component, bonded to the second component, mounted to the second component, welded to the second component, fastened to the second component, or connected to the second component in some other suitable manner. The first component also may be connected to the second component using a third component. The first component may also be considered to be physically associated with the second component by being formed as part of the second component, being an extension of the second component, or both.

Targets 112 may take a number of different forms. For example, targets 112 may be selected from at least one of a decal, a painted target, or some other suitable form. The form of a target in targets 112 may be different from one location to another location on aircraft structure 108. For example, targets 112 may have at least one of a different shape, a different color, or other characteristic from location to location on aircraft structure 108.

In this illustrative example, aircraft monitoring system 107 also includes camera system 114, which is configured to generate images 116 of targets 112 during operation 128 of aircraft 102. As depicted, operation 128 of aircraft 102 is selected from one of taxiing, cruising, ascending, descending, taking off, landing, or some other suitable type of operation 128 for aircraft 102.

Images 116 are used by monitor 106 to monitor aircraft structure 108. Images 116 are of targets 112 associated with aircraft structure 108.

As depicted, monitor 106 is configured to measure movement 118 of targets 112 using images 116. In this manner, identifying aircraft structure movement 120 is enabled. In this illustrative example, aircraft structure movement 120 is a vibration of aircraft structure 108. Aircraft structure movement 120 may be selected from at least one of bending, deflection, twisting, or some other movement of aircraft structure 108 from its original form before a force or load is applied to aircraft structure 108 during flight of aircraft 102. Further, aircraft structure movement 120 may be intentional movement of aircraft structure 108. For example, aircraft structure movement 120 may be a deployment of aircraft structure 108 when aircraft structure 108 takes the form of a control surface such as a flap, a slat, or a spoiler. With aircraft structure movement 120, stress 122 may be identified for aircraft structure 108.

In this illustrative example, monitor 106 may measures movement 118 of targets 112 at location 124 on aircraft structure 108 using images 116. By measuring movement 118 of targets 112 at location 124, monitor 106 identifies stress 122 at location 124. Stress 122 may result in the aircraft structure movement 120 from one position to another position when a load or force is applied. Stress 122 also may result from aircraft structure movement 120 occurring continuously, such as a vibration of aircraft structure 108.

The identification of stress 122 is performed in real time in the illustrative example. In other words, stress 122 is identified as quickly as possible without any intentional delay during operation of aircraft 102. Monitor 106 is configured to identify stress 122 in aircraft structure 108 at location 124 in real time in this illustrative example. Stress 122 may be identified using vibrations detected in dynamic movement of aircraft structure 108.

Further, monitor 106 may take in account movements that are not part of movement 118 for targets 112. For example, in measuring movement 118 of targets 112 using images 116, monitor 106 is configured to compensate for additional movement 126 from camera system 114 or from other sources in aircraft 102. In this illustrative example, camera system 114 is located in a location within aircraft 102.

As depicted, with the identification of stress 122, monitor 106 may perform action 130. Action 130 may take a number of different forms. For example, action 130 maybe selected from one of initiating a maintenance request, initiating a maneuver, halting a maneuver, changing a flight parameter, generating an alert indicating that maintenance is needed, sending a report on stress 122, generating an internal alert for the flight crew, recording stress 122, or other suitable actions.

Monitor 106 may be implemented in software, hardware, firmware, or a combination thereof. When software is used, the operations performed by monitor 106 may be implemented in a program code configured to run on hardware, such as a processor unit. When firmware is used, the operations performed by monitor 106 may be implemented in a program code and data that is stored in persistent memory to run on a processor unit. When hardware is employed, the hardware may include circuits that operate to perform the operations in monitor 106.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform a number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components, excluding a human being. For example, the processes may be implemented as circuits in organic semiconductors.

Computer system 132 is a physical hardware system and includes one or more data processing systems. As depicted, computer system 132 is located in aircraft 102. Computer system 132 may include data processing systems for components such as a flight management system, an engine indication and crew alerting system, a navigation system, an autopilot, or other suitable components in aircraft 102.

When more than one data processing system is present, those data processing systems are in communication with each other using a communications medium. The communications medium may be a network. The data processing systems may be selected from at least one of a computer, a server computer, a tablet, or some other suitable data processing system.

In one illustrative example, one or more technical solutions are present that overcome a technical problem with measuring movement of aircraft structures. For example, the illustrative examples overcome issues including complexity, time, or weight involved with using current techniques, such as accelerometers. As depicted, monitor 106 uses photogrammetry to measure dynamic movements in aircraft structure movement 120 of aircraft structure 108 through detecting movement 118 of targets 112. Monitor 106 also may be used to detect static movement in aircraft structure movement 120 of aircraft structure 108. In this manner, monitor 106 may be dynamic movement currently performed using accelerometers in addition to static movement. As a result, monitor 106 may be used to calculate stress 122 identified using vibrations that occur in dynamic movement of aircraft structure 108.

Further, the vibrations may be detected during operation 128 of aircraft 102. As a result, stress 122 may be calculated for different vibration characteristics that may occur during different phases of operation of aircraft 102. In other words, the identification of stress 122 may be detected while aircraft 102 is in flight and in real time using the same data generated by camera system 114 and targets 112.

As a result, one or more technical solutions may provide a technical effect reducing at least one of the expense, time, or weight for monitoring movement of an aircraft structure. For example, the cost and weight of hardware such as pressure sensors or accelerometers may be avoided. Further, the cost and weight in the wiring in instrumentation for these types of devices also may be avoided. In this manner, the time, expense, and weight of current systems may be avoided. As a result, time and expense may be reduced in the development and certification of the aircraft.

In another illustrative example, maintenance may be identified and scheduled during operation of aircraft 102. In another illustrative example, monitor 106 may be used to identify when a maneuver should be changed or canceled during operation 128 of aircraft 102.

Further, computer system 132 operates as a special purpose computer system in which monitor 106 in computer system 132 enables monitoring of aircraft structures 104 in a manner that allows for identifying stress 122 in the aircraft structure. Computer system 132 operates to identify movement 118 of targets 112 in a manner that allows for performing action 130. For example, if stress 122 is identified from movement 118, action 130, such as maintenance, a change in flight of aircraft 102, or other suitable actions may be performed.

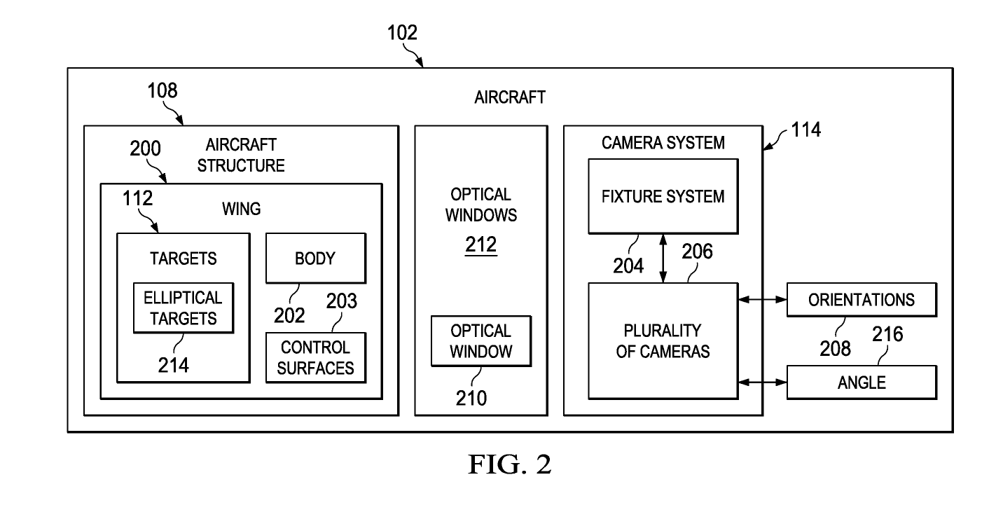

With reference next to FIG. 2, an illustration of a block diagram of a more detailed example of an aircraft monitoring system is depicted in accordance with an illustrative embodiment. In the illustrative examples, the same reference numeral may be used in more than one figure. This reuse of a reference numeral in different figures represents the same element in the different figures.

In this more detailed example, aircraft structure 108 takes the form of wing 200. Wing 200 includes body 202, control surfaces 203, and other structures that may be considered part of wing 200. Body 202 is an airfoil in this example. Control surfaces 203 are structures that may be used to control the airflow over wing 200

As depicted, camera system 114 is located inside of body 202 of aircraft 102. Camera system 114 is selected to generate images 116 of FIG. 1 quickly enough such that comparisons between images 116 may be made to identify movement 118 of FIG. 1 of targets 112 in a manner that allows for identifying stress 122 of FIG. 1. For example, camera system 114 may be selected from at least one of a photogrammetry camera system, a stereo photogrammetry system, or some other suitable type of camera system.

When camera system 114 is a photogrammetry camera system, measurements from photographs are used to identify positions of surface points such as targets 112. Moreover, the photogrammetry camera system may be used to recover the motion pathways of one or more of targets 112 located on wing 200, on its components and in the immediately adjacent environment. Photogrammetric analysis may be applied to one photograph, or may use high-speed photography and remote sensing to detect, measure, and record complex 2-D motion fields and 3-D motion fields to identify movement 118 of targets 112.

For example, oscillatory vibrations of interest on an aircraft structure 108 such as a wing, flaps, slats, or a horizontal tail, are in the range of about 5 Hz to about 400 Hz. With speed of movement of targets 112, an 800 frames per second (fps) camera, including Nyquist criteria, may be used to measure the vibration characteristic of these surfaces from movement 118 of targets 112.

In this illustrative example, camera system 114 comprises fixture system 204 and plurality of cameras 206. Fixture system 204 may be any platform, frame, or other structure on which plurality of cameras 206 may be mounted or otherwise attached.

As depicted, plurality of cameras 206 is associated with fixture system 204. The association is such that orientations 208 for plurality of cameras 206 are set independently. The number of cameras in plurality of cameras 206 may vary depending on the particular implementation. For example, the plurality of cameras may be two cameras, 11 cameras, 31 cameras, or some other suitable number of cameras.

In this example, optical window 210 is present in body 202 of the aircraft. Optical window is any window that allows for a desired level of clarity, accuracy, weather design parameters for analyzing images 116 to identify movement 118 of targets 112. In this illustrative example, camera system 114 of FIG. 1 is positioned to generate images from inside of aircraft 102 with a view through optical window 210. One or more of plurality of cameras 206 may be positioned to generate images 116 with a view through optical window 210.

In other illustrative examples, optical window 210 is one window in optical windows 212. One or more of plurality cameras 206 may be positioned at optical windows 212 to generate images 116.

Further in this illustrative example, targets 112 are selected to be visible to camera system 114 in sunlight. Also, targets 112 may be elliptical targets 214. For example, elliptical targets 214 may have a shape that is selected such that elliptical targets 214 in images 116 generated by camera system 114 are circular based on angle 216 of camera system 114 to elliptical targets 214.

The illustration of aircraft monitoring environment 100 and the different components in FIGS. 1-2 are not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, targets 112 may be present on other aircraft structures in aircraft structures 104 in addition to or in place of aircraft structure 108. A movement of targets 112 may be into another position or the movement of targets 112 may be one that is dynamic such as those when vibrations occur. This movement may be from an unloaded state to a loaded state of aircraft structure 108. The change in position of targets 112 may be used to identify stress on aircraft structure 108. This stress may be identified for dynamic movements of targets 112 such as those that occur with vibrations in which targets 112 continues to move into different positions.

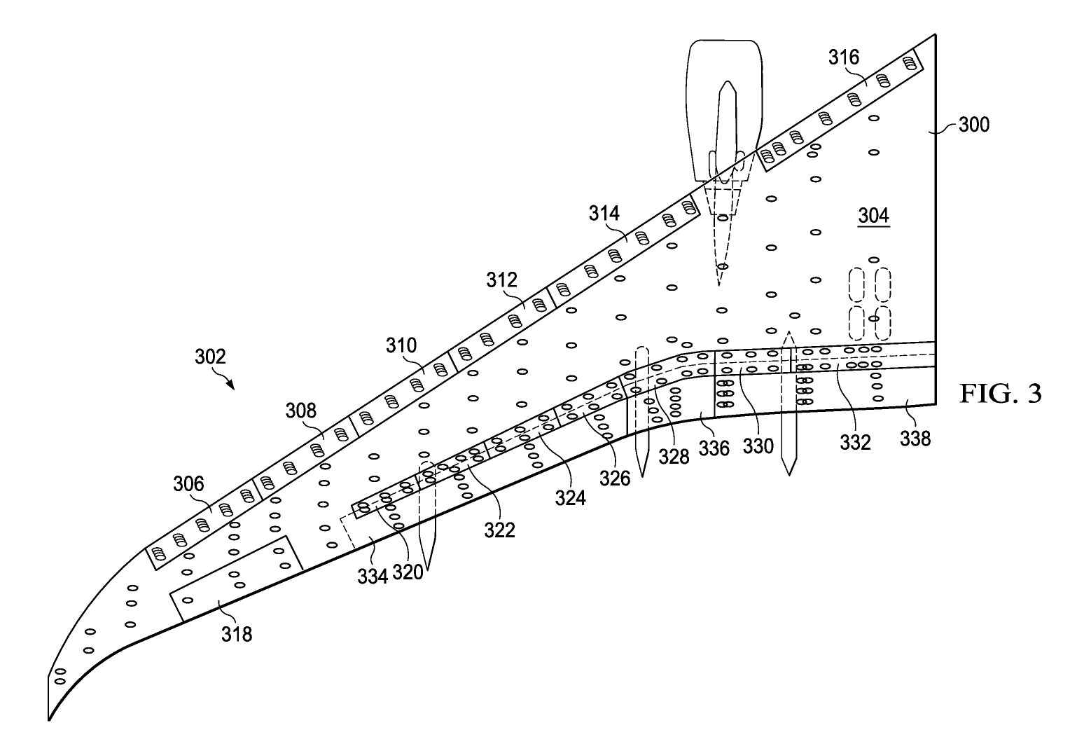

With reference now to FIG. 3, an illustration of a wing with targets is depicted in accordance with an illustrative embodiment. In this illustrative example, wing 300 has elliptical targets 302 associated with wing 300. In this example, wing 300 is an example of one physical implementation for aircraft structure 108, shown in block form in FIG. 1. Elliptical targets 302 are examples of one physical implementation for targets 112 shown in block form in FIG. 1 and elliptical targets 214 shown in block form in FIG. 2.

In this illustrative example, elliptical targets 302 at locations on wing 300. The selection of the locations may be made in a number of different ways. Locations may be selected based on different portions of wing 300 for which stress is to be identified.

As depicted, wing 300 comprises airfoil 304 as a body or primary structure of wing 300. Wing 300 also includes control surfaces in the form of outboard slat 306, outboard slat 308, outboard slat 310, outboard slat 312, outboard slat 314, inboard slat 316, aileron 318, spoiler 320, spoiler 322, spoiler 324, spoiler 326, hinge panel 328, spoiler 330, spoiler 332, flap 334, flaperon 336, and flap 338.

As illustrated, the locations at these different parts of wing 300 have elliptical targets 302. In this manner, movement of elliptical targets 302 located at the different parts of wing 300 is identified during operation of the aircraft. In this illustrative example, the movement of elliptical targets 302 may be used to identify movement such as bending, torsion, or other suitable movement. Further, the movement of elliptical targets 302 may be used to identify stress in the different parts.

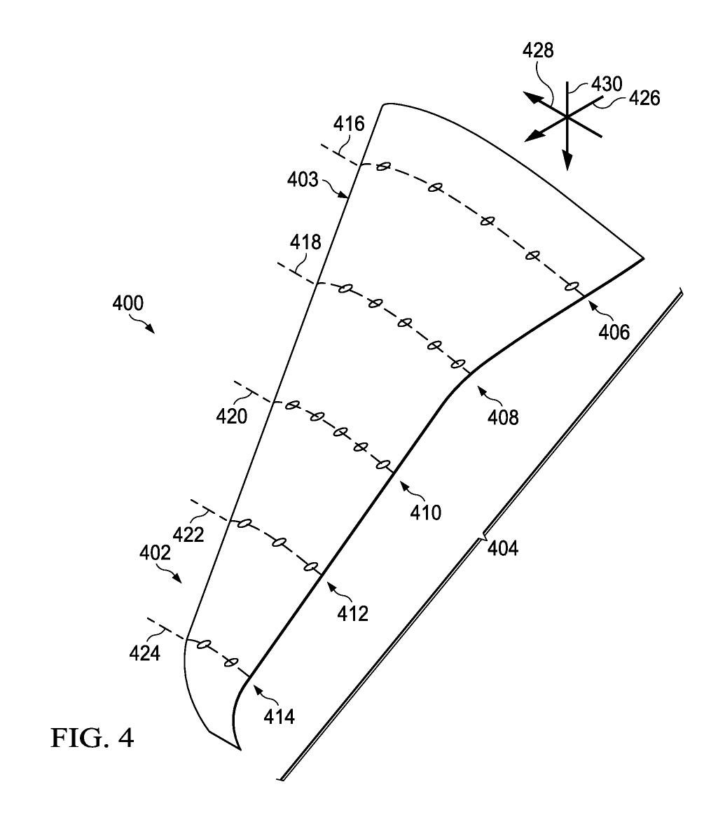

Turning to FIGS. 4-6, illustrations of the identification of movement in a wing of an aircraft is depicted in accordance with an illustrative embodiment. With reference to FIG. 4, an illustration of a wing with elliptical targets is depicted in accordance with an illustrative embodiment. In this illustrative example, the movement may be performed using a monitor, such as monitor 106 in FIG. 1.

In this particular example, wing 400 is an example of a physical implementation for aircraft structure 108 shown in block form in FIG. 1, and in particular, wing 200 shown in block form in FIG. 2. Elliptical targets 402 on wing 400 are examples of physical implementations for targets 112 shown in block form in FIG. 1 and elliptical targets 214 shown in block form in FIG. 2.

In this illustrative example, elliptical targets 402 are decals that are affixed to surface 403 of wing 400. As depicted, elliptical targets 402 are arranged in rows 404 on wing 400. Rows 404 include row 406, row 408, row 410, row 412, and row 414. The rows are shown aligned along the butt line 416, butt line 418, butt line 420, butt line 422, and butt line 424.

With this arrangement of elliptical targets 402, a reference data set is identified. In the depicted example, the reference data set is identified relative to a pitch axis 426, roll axis 428, and yaw axis 430.

Station references, butt line references, and waterline references are described using coordinates based on pitch axis 426, roll axis 428, and yaw axis 430. Butt line references are set along pitch axis 426, station references are set along roll axis 428, and waterline references are set along yaw axis 430 in this illustrative example. The waterline references set locations relative to the height of the upper and lower portion of the aircraft. The butt line references describe left and right portions of the aircraft relative to the centerline of the aircraft. The station references describe forward and aft portions of the aircraft along the centerline of the aircraft. In this example, the centerline is roll axis 428. These references along with different axes are used to describe different parts of the aircraft in a three-dimensional coordinate system for the aircraft.

In other illustrative examples, other coordinate systems may be used, different origins may be selected, or some combination thereof. For example, the origin may be selected in the cockpit rather than at the center of mass of the aircraft. In this illustrative example, vectors of deflection are primarily in the waterline direction.

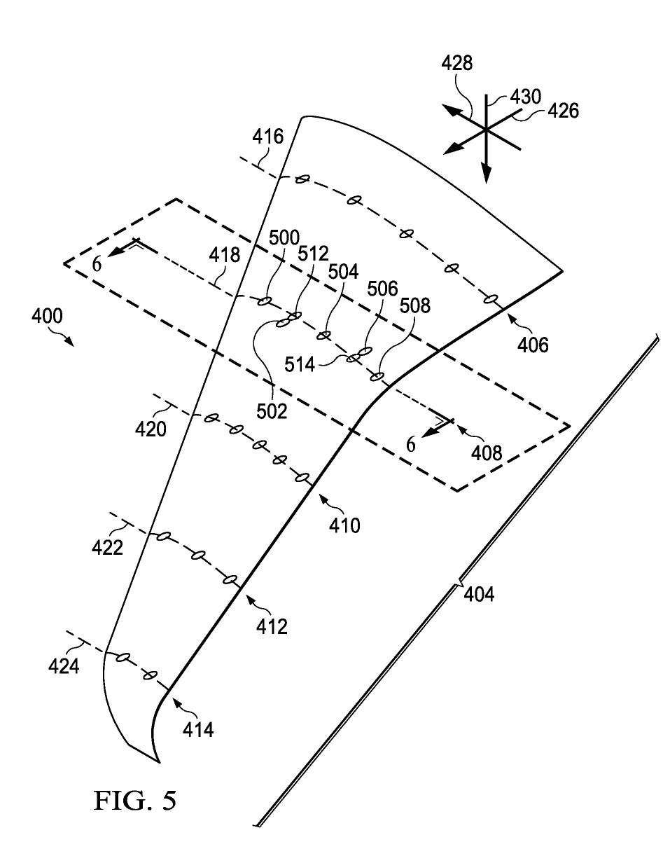

With reference next FIG. 5, an illustration of a deflection of a wing is depicted in accordance with an illustrative embodiment. In this example, a deflection of wing 400 is depicted. In this example, elliptical target 500, elliptical target 502, elliptical target 504, elliptical target 506, and elliptical target 508 are no longer all aligned along butt line 418. For example, elliptical target 502 has moved from original location 512 and elliptical target 506 has moved from original location 514. This movement of elliptical target 502 and elliptical target 506 is relative to butt line 418.

By using original location 512, original location 514, and the current locations of elliptical target 500, elliptical target 504, and elliptical target 508, deflection of wing 400 along butt line 418 may be identified. For example, a localized water line deflection section station and butt line position may be identified. The deflection may be a movement in the form of a bend in wing 400 or from oscillation of wing 400 such as a vibration of wing 400.

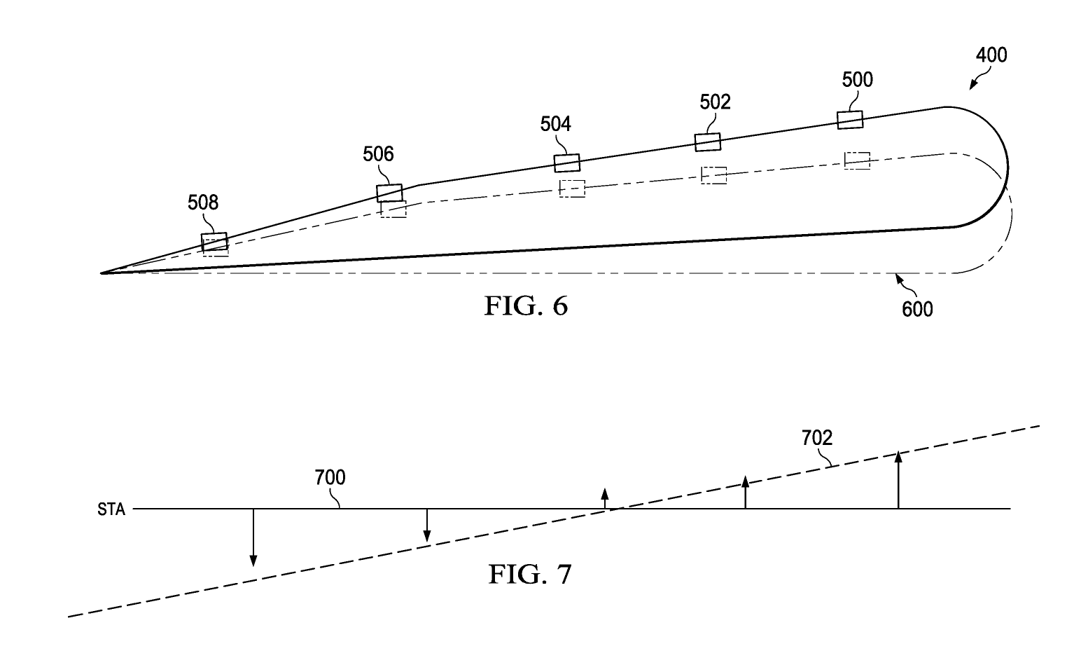

With reference now to FIG. 6, an illustration of a cross-sectional view of a wing is depicted in accordance with an illustrative embodiment. In this illustrative example, a cross-sectional view of wing 400 is seen taken along lines 6-6 in FIG. 5. In this view, elliptical target 500, elliptical target 502, elliptical target 504, elliptical target 506, and elliptical target 508 are shown in a current position. Original position and shape of wing 400 is shown with dotted line 600.

In this illustrative example, a best fit line may be computed through waterline references for each row. The slope of a line may be a twist at a particular butt line.

With this identification, at least one of bending or twisting of wing 400 along butt line 418 of FIG. 4 may be identified. This type of movement may be used to identify stress on wing 400.

With reference now to FIG. 7, an illustration of waterline deflection along stations extending longitudinally along a roll axis is depicted in accordance with an illustrative embodiment. In this illustrative example, line 700 represents stations extending along roll axis 428 in FIG. 4. Line 702 indicates waterline deflection of elliptical target 500, elliptical target 502, elliptical target 504, elliptical target 506, and elliptical target 508 of FIG. 5.

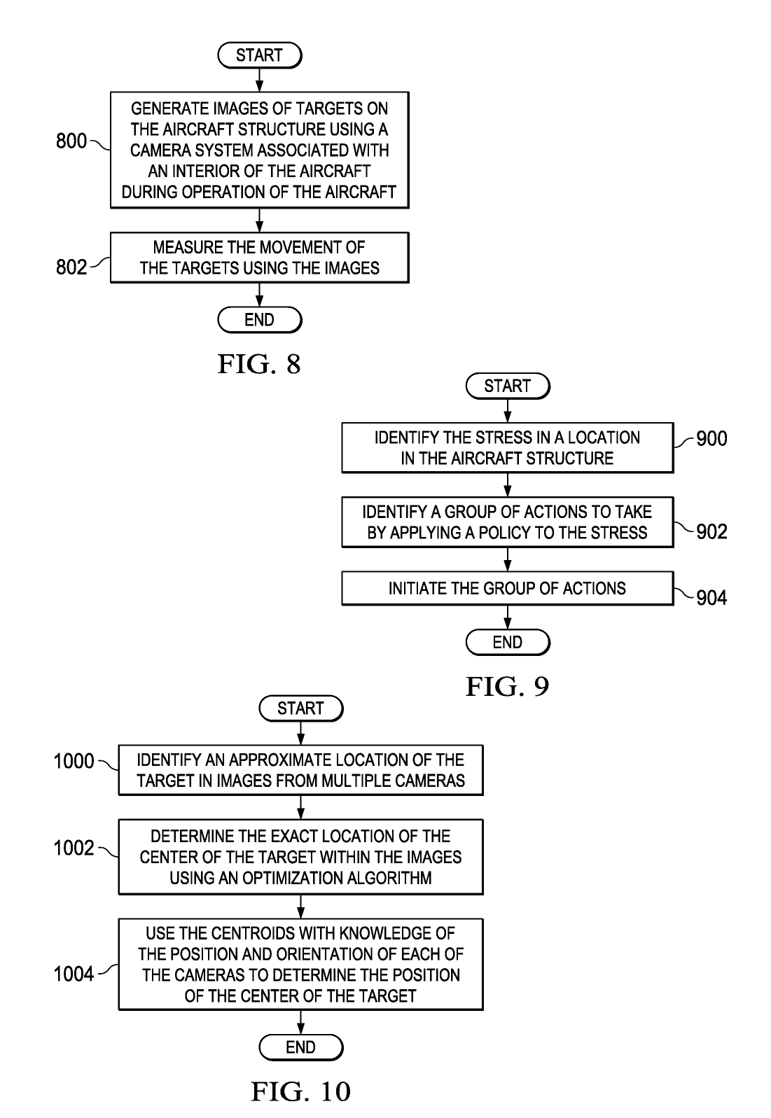

Turning next to FIG. 8, an illustration of a flowchart of a process for monitoring movement of an aircraft structure is depicted in accordance with an illustrative embodiment. The process illustrated in this figure may be implemented in monitor 106 in computer system 132 shown in block form in FIG. 1.

The process begins by generating images of targets on the aircraft structure using a camera system associated with an interior of the aircraft during operation of the aircraft (operation 800). The process measures the movement of the targets using the images (operation 802). The process terminates thereafter. These operations enable identifying the movement of the aircraft structure. As a result, the movement may be used to identify whether the movement is greater than the desired movement for the aircraft structure. Further, the movement may also be used to identify vibrations, stress, or other effects that may occur on the aircraft structure.

With reference now to FIG. 9, an illustration of a flowchart of a process for performing an operation in response to identifying stress in an aircraft structure is depicted in accordance with an illustrative embodiment. The process illustrated in this figure may be performed using monitor 106 in computer system 132 shown in block form in FIG. 1.

The process begins by identifying the stress in a location in the aircraft structure (operation 900). The location may be a portion or all of the aircraft structure in operation 900. The aircraft structure may be, for example, a wing, a control surface, or some other suitable aircraft structure.

The process then identifies a group of actions to take by applying a policy to the stress (operation 902). The policy is a group of rules. These rules may implement at least one of specifications, regulations, industry rules, or other requirements with respect to the aircraft structure. The rules also may identify actions that are to be taken.

As used herein, “a group of” when used with reference to items, means one or more items. For example, a group of actions is one or more actions.

The process then initiates the group of actions (operation 904) with the process terminating thereafter. For example, the process may initiate an alert to make a change in maneuver and send a maintenance request. In another example, the action may change an operating parameter for the aircraft. These and other actions may be taken pending the particular implementation.

With reference now to FIG. 10, a flowchart of a process for identifying movement of a target in images is depicted in accordance with an illustrative embodiment. This process may be used in operation 802 in FIG. 8 to measure the movement of targets.

The process begins by identifying an approximate location of the target in images from multiple cameras (operation 1000). In operation 1000 the images are taken at the same time.

The process then determines the exact location of the center of the target within the images using an optimization algorithm (operation 1002). The center of the target is a centroid and identified in the coordinate system for the image. As a result, the target will have coordinates within each image. The centroid coordinates will be different from each image.

The process uses the centroids with knowledge of the position and orientation of each of the cameras to determine the position of the center of the target (operation 1004). The process terminates thereafter.

In operation 1004, the position of the target is in aircraft coordinates. With this type of triangulation process, a three-dimensional location of the target is identified. Changes in the position of the target as computed from some other images acquired at a later time are used to identify movement of the target.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

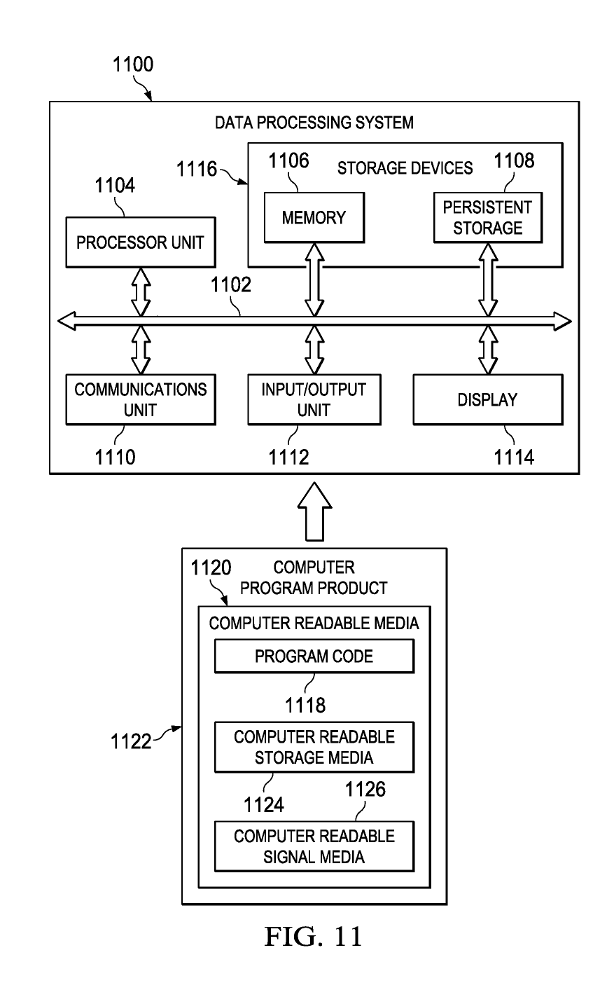

Turning now to FIG. 11, an illustration of a block diagram of a data processing system is depicted in accordance with an illustrative embodiment. Data processing system 1100 may be used to implement computer system 132 of FIG. 1. In this illustrative example, data processing system 1100 includes communications framework 1102, which provides communications between processor unit 1104, memory 1106, persistent storage 1108, communications unit 1110, input/output unit 1112, and display 1114. In this example, communication framework may take the form of a bus system.

Processor unit 1104 serves to execute instructions for software that may be loaded into memory 1106. Processor unit 1104 may be a number of processors, a multi-processor core, or some other type of processor, depending on the particular implementation.

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or on both a temporary basis and a permanent basis. Storage devices 1116 may also be referred to as computer readable storage devices in these illustrative examples. Memory 1106 may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a solid state hard drive, a flash memory drive, a rewritable optical disk, a rewritable magnetic tape, or some other combination of suitable storage devices. The media used by persistent storage 1108 also may be removable. For example, a removable hard drive may be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating systems, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer usable program code, or computer readable program code that may be read and executed by a processor in processor unit 1104. The program code in the different embodiments may be embodied on different physical or computer readable storage media, such as memory 1106 or persistent storage 1108.

Program code 1118 is located in a functional form on computer readable media 1120 that is selectively removable and may be loaded onto or transferred to data processing system 1100 for execution by processor unit 1104. Program code 1118 and computer readable media 1120 form computer program product 1122 in this illustrative example. In one example, computer readable media 1120 may be computer readable storage media 1124 or computer readable signal media 1126.

In these illustrative examples, computer readable storage media 1124 is a physical or tangible storage device used to store program code 1118 rather than a medium that propagates or transmits program code 1118.

Alternatively, program code 1118 may be transferred to data processing system 1100 using computer readable signal media 1126. Computer readable signal media 1126 may be, for example, a propagated data signal containing program code 1118. For example, computer readable signal media 1126 may be at least one of an electromagnetic signal, an optical signal, or any other suitable type of signal. These signals may be transmitted over at least one of communications links, such as wireless communications links, an optical fiber cable, a coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

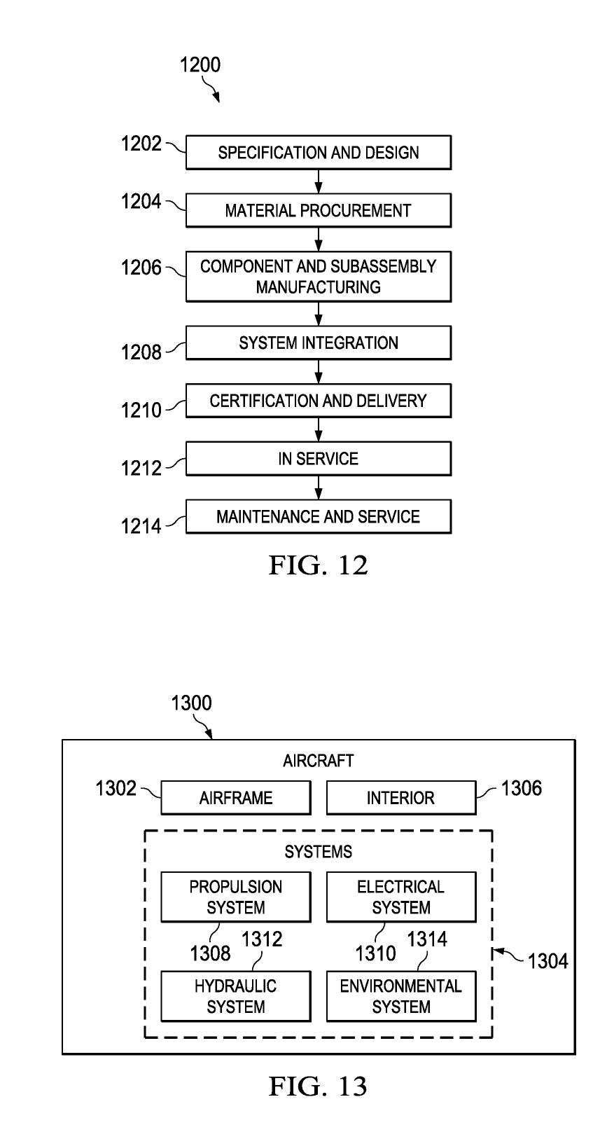

Illustrative embodiments of the present disclosure may be described in the context of aircraft manufacturing and service method 1200 as shown in FIG. 12 and aircraft 1300 as shown in FIG. 13. Turning first to FIG. 12, an illustration of a block diagram of an aircraft manufacturing and service method is depicted in accordance with an illustrative embodiment. During pre-production, aircraft manufacturing and service method 1200 may include specification and design 1202 of aircraft 1300 in FIG. 13 and material procurement 1204.

During production, component and subassembly manufacturing 1206 and system integration 1208 of aircraft 1300 in FIG. 13 takes place. Thereafter, aircraft 1300 in FIG. 13 may go through certification and delivery 1210 in order to be placed in service 1212. While in service 1212 by a customer, aircraft 1300 in FIG. 13 is scheduled for routine maintenance and service 1214, which may include modification, reconfiguration, refurbishment, or other maintenance and service.

Each of the processes of aircraft manufacturing and service method 1200 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 13, an illustration of a block diagram of an aircraft is depicted in which an illustrative embodiment may be implemented. In this example, aircraft 1300 is produced by aircraft manufacturing and service method 1200 in FIG. 12 and may include airframe 1302 with a plurality of systems 1304 and interior 1306. Examples of systems 1304 include one or more of propulsion system 1308, electrical system 1310, hydraulic system 1312, and environmental system 1314. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1200 in FIG. 12.

In one illustrative example, components or subassemblies produced in component and subassembly manufacturing 1206 in FIG. 12, may be fabricated or manufactured in a manner similar to components or subassemblies produced while aircraft 1300 is in service 1212 in FIG. 12. As yet another example, one or more apparatus embodiments, method embodiments, or a combination thereof, may be utilized during production stages, such as component and subassembly manufacturing 1206 and system integration 1208 in FIG. 12. One or more apparatus embodiments, method embodiments, or a combination thereof, may be utilized while aircraft 1300 is in service 1212, during maintenance and service 1214 in FIG. 12, or both. The use of a number of the different illustrative embodiments may substantially expedite the assembly of aircraft 1300, reduce the cost of aircraft 1300, or both expedite the assembly of aircraft 1300 and reduce the cost of aircraft 1300.

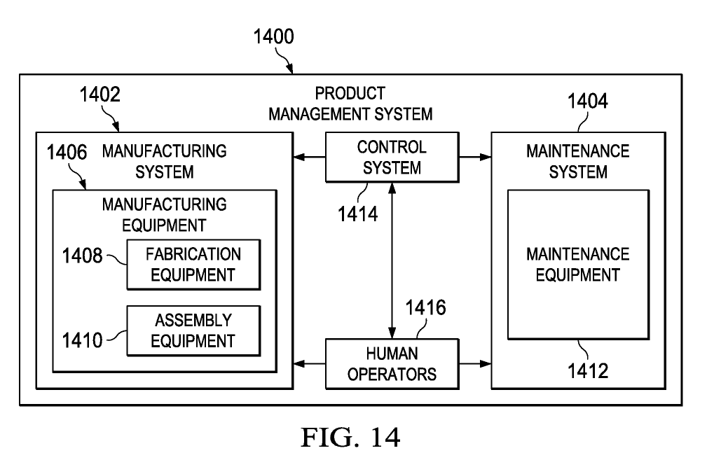

Turning now to FIG. 14, an illustration of a block diagram of a product management system is depicted in accordance with an illustrative embodiment. Product management system 1400 is a physical hardware system. In this illustrative example, product management system 1400 may include at least one of manufacturing system 1402 or maintenance system 1404.

Manufacturing system 1402 is configured to manufacture products, such as aircraft 1300 in FIG. 13. As depicted, manufacturing system 1402 includes manufacturing equipment 1406. Manufacturing equipment 1406 includes at least one of fabrication equipment 1408 or assembly equipment 1410.

Fabrication equipment 1408 is equipment that may be used to fabricate components for parts used to form aircraft 1300. For example, fabrication equipment 1408 may include machines and tools. These machines and tools may be at least one of a drill, a hydraulic press, a furnace, a mold, a composite tape laying machine, a vacuum system, a lathe, or other suitable types of equipment. Fabrication equipment 1408 may be used to fabricate at least one of metal parts, composite parts, semiconductors, circuits, fasteners, ribs, skin panels, spars, antennas, or other suitable types of parts.

Assembly equipment 1410 is equipment used to assemble parts to form aircraft 1300. In particular, assembly equipment 1410 may be used to assemble components and parts to form aircraft 1300. Assembly equipment 1410 also may include machines and tools. These machines and tools may be at least one of a robotic arm, a crawler, a faster installation system, a rail-based drilling system, or a robot. Assembly equipment 1410 may be used to assemble parts such as seats, horizontal stabilizers, wings, engines, engine housings, landing gear systems, or other parts for aircraft 1300.

In this illustrative example, maintenance system 1404 includes maintenance equipment 1412. Maintenance equipment 1412 may include any equipment needed to perform maintenance on aircraft 1300. Maintenance equipment 1412 may include tools for performing different operations on parts on aircraft 1300. These operations may include at least one of disassembling parts, refurbishing parts, inspecting parts, reworking parts, manufacturing replacement parts, or other operations for performing maintenance on aircraft 1300. These operations may be for routine maintenance, inspections, upgrades, refurbishment, or other types of maintenance operations.

In the illustrative example, maintenance equipment 1412 may include ultrasonic inspection devices, x-ray imaging systems, vision systems, drills, crawlers, and other suitable devices. In some cases, maintenance equipment 1412 may include fabrication equipment 1408, assembly equipment 1410, or both to produce and assemble parts that may be needed for maintenance.

Product management system 1400 also includes control system 1414. Control system 1414 is a hardware system and may also include software or other types of components. Control system 1414 is configured to control the operation of at least one of manufacturing system 1402 or maintenance system 1404. In particular, control system 1414 may control the operation of at least one of fabrication equipment 1408, assembly equipment 1410, or maintenance equipment 1412.

The hardware in control system 1414 may be using hardware that may include computers, circuits, networks, or other types of equipment. The control may take the form of direct control of manufacturing equipment 1406. For example, robots, computer-controlled machines, and other equipment may be controlled by control system 1414. In other illustrative examples, control system 1414 may manage operations performed by human operators 1416 in manufacturing or performing maintenance on aircraft 1300. For example, control system 1414 may assign tasks, provide instructions, display models, or perform other operations to manage operations performed by human operators 1416. In these illustrative examples, monitor 106 in FIG. 1 communicates with control system 1414 to manage at least one of the manufacturing or maintenance of aircraft 1300 in FIG. 13.

For example, monitor 106 in FIG. 1 may send information about stress for aircraft structures in aircraft 1300 in FIG. 13. The information about stress may be sent during operation of aircraft 1300, after aircraft 1300 has landed, during maintenance of aircraft 1300 or at other times. This information may be used to perform an operation selected from at least one of changing a design of aircraft 1300, scheduling maintenance for aircraft 1300, or other suitable operations that may be performed using product management system 1400.

Changes in design of aircraft 1300 may be implemented during manufacturing of parts, replacement parts, or other components for aircraft 1300 by control system 1414 controlling manufacturing system 1402. Control system 1414 controls at least one of scheduling of maintenance or performance of maintenance for aircraft 1300 using the stress identified for aircraft 1300.

In the different illustrative examples, human operators 1416 may operate or interact with at least one of manufacturing equipment 1406, maintenance equipment 1412, or control system 1414. This interaction may be performed to manufacture aircraft 1300.

Of course, product management system 1400 may be configured to manage other products other than aircraft 1300. Although product management system 1400 has been described with respect to manufacturing in the aerospace industry, product management system 1400 may be configured to manage products for other industries. For example, product management system 1400 may be configured to manufacture products for the automotive industry as well as any other suitable industries.

Thus, the illustrative embodiments provide one or more technical solutions are present that overcome a technical problem with measuring movement of aircraft structures. For example, the illustrative examples overcome issues including of complexity, time, or weight involved with using current techniques such as accelerometers.

Further, the illustrative examples may be used to identify vibrations occurring during dynamic movement of an aircraft structure. These vibrations may be used to identify stress that may occur. Additionally, the vibrations may be identified during different times and phases of flight of the aircraft. As a result, vibration cycles may be identified and changes in stress on an aircraft structure for an aircraft also may be identified dynamically and in real time using the same data generated using the camera system and targets on the aircraft structure. Of course, these types of identifications also may be made after flight of an aircraft in other illustrative examples.

As a result, one or more technical solutions may provide a technical effect reducing at least one of the expense, time, or weight for monitoring movement of an aircraft structure. In this manner, the time, expense, and weight of current systems may be avoided. As a result, the development and certification of aircraft may be performed more quickly and with a lower expense. Further, one or more illustrative embodiments may be used to monitor the aircraft to identify when maintenance should be scheduled for an aircraft. In another illustrative example, the monitor may be used to identify when a maneuver should be changed or canceled during flight of an aircraft.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An aircraft monitoring system comprising:
targets associated with a wing of an aircraft;
a camera system configured to generate images of the targets on the wing during operation of the aircraft; and
a monitor configured to measure a movement of the targets using the images, enabling identifying wing movement.

2. The aircraft monitoring system of claim 1, wherein the monitor measures the movement of the targets at a location on the wing using the images.

3. The aircraft monitoring system of claim 2, wherein the monitor is configured to identify stress in the wing at the location in real time using vibrations detected in dynamic movement of an aircraft structure.

4. The aircraft monitoring system of claim 3, wherein the monitor is configured to identify maintenance for the aircraft based on the stress in the wing at the location.

5. The aircraft monitoring system of claim 1, wherein in measuring the movement of the targets using the images, the monitor compensates for additional movement from the camera system.

6. The aircraft monitoring system of claim 1 further comprising:
an optical window in a body of the aircraft, wherein the camera system is positioned to generate the images from inside the aircraft with a view through the optical window.

7. The aircraft monitoring system of claim 1, wherein the camera system is selected from at least one of a photogrammetry camera system or a stereo photogrammetry system.

8. The aircraft monitoring system of claim 1, wherein the camera system comprises:
a fixture system; and
a plurality of cameras associated with the fixture system in which orientations for the plurality of cameras are set independently.

9. The aircraft monitoring system of claim 1, wherein the targets are elliptical targets, and wherein the elliptical targets in the images are circular based on an angle of the camera system to the elliptical targets.

10. The aircraft monitoring system of claim 1, wherein the targets are selected to be visible to the camera system in sunlight.

11. The aircraft monitoring system of claim 1, wherein the wing movement is selected from at least one of bending, deflection or a twisting.

12. The aircraft monitoring system of claim 1, wherein operation of the aircraft is selected from one of taxiing, cruising, ascending, descending, taking off, or landing.

13. A real-time aircraft stress monitoring system comprising:
elliptical targets associated with a wing of an aircraft;
a camera system configured to generate images of the elliptical targets on the wing during operation of the aircraft, wherein the elliptical targets in the images are circular based on an angle of the camera system to the elliptical targets; and
a monitor that measures a movement of the elliptical targets using the images and identifies stress in the wing based on the movement of the elliptical targets.

14. The real-time aircraft stress monitoring system of claim 13, wherein the monitor generates an alert for maintenance using the stress identified in the wing.

15. A method for monitoring movement of an aircraft structure, the method comprising:
generating images of targets on the aircraft structure using a camera system associated with an interior of an aircraft during operation of the aircraft; and
measuring movement of the targets using the images, enabling identifying the movement of the aircraft structure.

16. The method of claim 15, wherein measuring the movement of the targets using the images comprises:
measuring the movement of the targets at a location on a wing using the images.

17. The method of claim 16 further comprising:
identifying a stress in the wing at the location in real-time.

18. The method of claim 17, wherein a monitor is configured to identify maintenance for the aircraft based on the stress in the wing at the location.

19. The method of claim 15, wherein in measuring the movement of the targets using the images, a monitor compensates for additional movement from the camera system.

20. The method of claim 15, wherein an optical window is present in a body of the aircraft and wherein the camera system is positioned to generate the images from inside of the aircraft with a view through the optical window.

21. The method of claim 15, wherein the camera system is selected from at least one of a photogrammetry camera system or a stereo photogrammetry system.

22. The method of claim 15, wherein the targets are elliptical targets, and wherein the elliptical targets in the images are circular based on an angle of the camera system to the elliptical targets.

23. The method of claim 15, wherein the movement of the aircraft structure is selected from at least one of a bending, deflection, or twisting.

24. The method of claim 15, wherein the operation of the aircraft is selected from one of taxiing, cruising, ascending, descending, taking off, and landing.
